(19) United States
(12) Patent Application Publication
(10) Pub. No.: US 2026/0149448 A1
(43) Pub. Date: May 28, 2026

(54) CURRENT MODE WEAK-PUF CIRCUIT WITH RICH CHALLENGE-RESPONSE PAIRS

(71) Applicant: Wenzhou University, Zhejiang (CN)

(72) Inventors: Gang LI, Zhejiang (CN); Pengjun WANG, Zhejiang (CN); Hui Li, Zhejiang (CN); Xilong Shao, Zhejiang (CN)

(73) Assignee: Wenzhou University, Zhejiang (CN)

(21) Appl. No.: 19/026,499

(22) Filed: Jan. 17, 2025

(30) Foreign Application Priority Data
Nov. 28, 2024 (CN) 202411719373.4

(51) Int. Cl. H03K 17/687; H04L 9/32

(52) U.S. Cl. CPC H03K 17/6872; H04L 9/3278

(57) ABSTRACT

A current mode weak-PUF circuit with rich challenge-response pairs includes a first decoder, a second decoder, a third decoder, a fourth decoder, a first PUF array, a second PUF array, two transmission gate arrays and one shared head. Each PUF array comprises 2^{q} column units (q is an integer greater than 1). Each column unit comprises 2^{p} NMOS units (p is an integer greater than 1). The first PUF array and the second PUF array respectively work in the following way: under the decoding action of challenge signals by the first decoder, the third decoder, the second decoder, and the fourth decoder, a certain NMOS unit in a certain column unit in the first PUF array performs comparison with any NMOS unit in any column unit in the second PUF array to generate a final output response.

### CROSS REFERENCE TO THE RELATED APPLICATIONS

This application is based upon and claims priority to Chinese Patent Application No. 202411719373.4, filed on Nov. 28, 2024, the entire contents of which are incorporated herein by reference.

### BACKGROUND

### Technical Field

The present disclosure relates to a weak PUF circuit and, in particular to, a current mode weak-PUF circuit with rich challenge-response pairs.

### Description of Related Art

With the rapid development of Internet of Things (IoT) technology, more and more IoT devices are connected to the network to form an IoT system, which brings unlimited possibilities to our production and life. Users can remotely access IoT devices through the Internet, control IoT devices, and realize communication between IoT devices and between users and IoT devices. Because the communication between IoT devices and between users and IoT devices is carried out on an open channel, the data transmitted in the IoT system can be stolen easily by attackers. As a cornerstone to ensure information security, the encryption algorithm implemented by key generation technology encrypts the data transmitted in the IoT system through generated keys to prevent data leakage or access by unauthorized users. However, traditional encryption methods need to store keys in non-volatile memories (NVMs), which is unacceptable for IoT devices with limited costs and resources. In addition, the keys stored in NVMs are also at risk of being physically attacked.

In order to cope with the above shortcomings, the physically unclonable function (PUF) technology came into being. The PUF can generate characteristic information with randomness, uniqueness and tamper-proof characteristics by extracting the random process deviations that are inevitably introduced during chip manufacturing, thus achieving lightweight deployment of key generation. Researchers classify PUF as strong PUF circuits and weak PUF circuits based on whether there is PUF unit reuse in the process of generating challenge-response pairs (CRPs) by PUF. Since there is no reuse relationship between PUF units in weak PUF circuits, it cannot be modeled and attacked by machine learning algorithms, and weak PUF circuits become the first choice for generating high-security keys. However, the traditional weak PUF circuit will cause the output response bit to flip under the influence of changes in the external working environment and internal thermal noise. In the meanwhile, due to the low entropy source utilization of weak PUF circuits and the surge in the area of weak PUF circuits caused by filtering strategies, it is seriously difficult to deploy weak PUF circuits in resource-constrained IoT devices.

A dual-entropy-superposed weak PUF composed of a two-transistor bias voltage generation circuit and a four-stage diode clamp circuit was reported by Zhao et al., “X. Zhao, C. Xie, Q. Zhao, and X. Pan, “A Dual-Entropy-Superposed PUF With In-Cell Entropy Sign-Based Stabilization.” IEEE Transactions on Circuits and Systems I: Regular Papers, 2022, 69(1), pp: 284-296.”. The dual-entropy-superposed weak PUF can only double the number of CRPs but increases the hardware overhead. A 2D sequence-dependent PUF based on SRAM by splitting the traditional SRAM structure was reported by Lu et al. (“L. Lu, and T. T. H. Kim, “A Sequence-Dependent Configurable PUF Based on 6T SRAM for Enhanced Challenge Response Space.” IEEE International Symposium on Circuits and Systems (ISCAS), 2019.”). The PUF configures the order of SRAM cell selection (i.e., PUF cell). Each SRAM cell has a vertical bit line and a horizontal word line. Four SRAM cells are connected simultaneously using orthogonal word lines to generate 1-bit data, thereby increasing the number of CRPs. However, the hardware overhead is large and the implementation is more complicated. An SRAM PUF with an SRAM cell consisting of 6 transistors was reported by Jeloka et al. (“S. Jeloka, K. Supreet, M. Kaiyuan Yang, et al. “A Sequence Dependent Challenge-Response PUF using 28 nm SRAM 6 T Bit Cell.” Symposium on VLSI Circuits, 2017, pp: C270-C271.”). By selecting any two lines from the PUF array for comparison, the number of CRPs can be expanded by an order of magnitude, but with a large hardware overhead.

### SUMMARY

The technical problem to be solved by the present disclosure is to provide a current mode weak-PUF circuit with rich challenge-response pairs, which can significantly increase the number of CRPs with low hardware overhead.

A technical solution adopted by the present disclosure to solve the above technical problems is: a current mode weak-PUF circuit with rich challenge-response pairs, comprising a first decoder, a second decoder, a third decoder, a fourth decoder, two PUF arrays, two transmission gate arrays and one shared head, wherein each PUF array comprises 2^{q} column units (q is an integer greater than 1), each column unit comprises 2^{p} NMOS (N-type Metal-Oxide-Semiconductor) units (p is an integer greater than 1), each NMOS unit comprises an NMOS transistor, the two PUF arrays are designated first PUF array and second PUF array respectively, and the two transmission gate arrays are designated first transmission gate array and second transmission gate array respectively; the first decoder is used to access first p challenge signals in one set, decode the challenge signals into 2^{p} row selection signals, and output the row selection signals to the first PUF array; the first PUF array is controlled by the 2^{p} row selection signals, one NMOS unit in each column unit of the first PUF array is selected and turned on to work in a subthreshold region to generate one response and output the one response to the first transmission gate array, that is, the first PUF array generates and outputs 2^{q} responses to the first transmission gate array; the second decoder is used to access second p challenge signals in one set, decode the second p challenge signals into 2^{p} row selection signals and output the row selection signals to the second PUF array; the second PUF array is controlled by the 2^{p} row selection signals, one NMOS unit in each column unit of the second PUF array is selected and turned on to generate one response and output the one response to the second transmission gate array, that is, the second PUF array generates and outputs 2^{q} responses to the second transmission gate array; the third decoder is used to access first q challenge signals in one set and decode the challenge signals into 2^{q} selection signals and output the 2^{q} selection signals to the first transmission gate array; the fourth decoder is used to access second q challenge signals and decode the challenge signals into 2^{q} selection signals and output the 2^{q} selection signals to the second transmission gate array; the first transmission gate array is controlled by the 2^{q} selection signals output by the third decoder, the first transmission gate array is used to select one of the 2^{q} responses output thereto by the first PUF array and output the one response to the shared header; the second transmission gate array is controlled by the 2^{q} selection signals output by the fourth decoder, the second transmission gate array is used to select one of the 2^{q} responses output thereto by the second PUF array and output the one response to the shared header; the shared header is used to compare the one response output thereto by the first transmission gate array with the one response output thereto by the second transmission gate array, and generate and output a final PUF response according to a comparison result.

Compared with the prior art, the present disclosure has the following advantages: a weak PUF circuit is constructed by a first decoder, a second decoder, a third decoder, a fourth decoder, two PUF arrays (a first PUF array and a second PUF array), two transmission gate arrays and a shared header; each PUF array comprises 2^{q} column units (q is an integer greater than 1), each column unit comprises 2^{p} NMOS units (i.e., PUF units) (p is an integer greater than 1), and each NMOS unit comprises an NMOS transistor; by using first p challenge signals in one set and second p challenge signals in one set, the same or different, and first q challenge signals in one set and second q challenge signals in one set, the same or different, under the decoding action of the first decoder and the third decoder on the challenge signals input thereto and under the decoding action of the second decoder and the fourth decoder on the challenge signals input thereto, a certain NMOS unit in a certain column unit in the first PUF array can perform comparison with any NMOS unit in any column unit in the second PUF array, so as to output a final response; that is, when there are 2^{q} column units in each of the first PUF array and the second PUF array, and 2^{p} NMOS units in each column unit, the weak PUF circuit of the present disclosure uses the NMOS transistor working in the subthreshold region as an entropy source to amplify process deviations in the manufacturing process and improve the stability of PUF, and also uses a one-to-many configuration of entropy sources to increase the number of CRPs from 2^{p+q} to (2^{p+q})² and increase the PUF entropy utilization rate by 2^{p+q} times. In view of this, the weak PUF circuit of the present disclosure can significantly increase the number of CRPs with less hardware overhead.

Further, p=6, q=3; the first decoder and the second decoder each have six input terminals and 64 output terminals, the third decoder and the fourth decoder each have three input terminals and eight output terminals, each of the transmission gate arrays has eight input terminals, eight selection terminals and one output terminal, each of the PUF arrays has 64 input terminals, one bias terminal and eight output terminals, and the shared head has one enable terminal, one pre-charge terminal, 2 input terminals and one output terminal; the 64 output terminals of the first decoder are connected one-to-one with the 64 input terminals of the first PUF array, the 64 output terminals of the second decoder are connected one-to-one with the 64 input terminals of the second PUF array, the bias terminal of the first PUF array is connected to the bias terminal of the second PUF array, and the connection terminal thereof serves as a bias terminal of the current mode weak-PUF circuit with rich challenge-response pairs and is used to access a bias signal VBB, and the bias signal VBB is used to allow the NMOS transistors in the first PUF array and the second PUF array to work in the subthreshold region; the eight output terminals of the third decoder are connected one-to-one with the eight selection terminals of the first transmission gate array, the eight output terminals of the first PUF array are connected one-to-one with the eight input terminals of the first transmission gate array, the eight output terminals of the fourth decoder are connected one-to-one with the eight selection terminals of the second transmission gate array, the eight output terminals of the second PUF array are connected one-to-one with the eight input terminals of the second transmission gate array, and the output terminals of the first transmission gate array and the output terminals of the second transmission gate array are connected one-to-one with the two input terminals of the shared header; the six input terminals of the first decoder, the three input terminals of the third decoder, the six input terminals of the second decoder and the three input terminals of the fourth decoder constitute 18 challenge terminals of the current mode weak-PUF circuit with rich challenge-response pairs, and the 18 challenge terminals are used to access 18 challenge signals; the enable terminal of the shared head serves as an enable terminal of the current mode weak-PUF circuit with rich challenge-response pairs and is used to access an enable signal, and the pre-charge terminal of the shared head serves as a pre-charge terminal of the current mode weak-PUF circuit with rich challenge-response pairs and is used to access a pre-charge signal.

Further, in each PUF array, each column unit has 64 input terminals, bias terminals and output terminals, and in each column unit, each NMOS unit has an input terminal, a bias terminal and an output terminal; the NMOS transistor of each NMOS unit is designated first NMOS transistor, a gate terminal of the first NMOS serves as the input terminal of the NMOS unit, a drain terminal of the first NMOS serves as the bias terminal of the NMOS unit, a source terminal of the first NMOS serves as the output terminal of the NMOS unit, and the input terminal of the j-th NMOS unit is the j-th input terminal of the column unit (j=1,2, . . . ,64); the bias terminals of 64 NMOS units are connected, and connection terminals thereof serve as the bias terminals of the column unit; the output terminals of 64 NMOS units are connected, and the connection terminals thereof serve as the output terminals of the column units; i-th input terminals of the eight column units are connected, and connection terminals thereof serve as the i-th input terminals of the PUF array (i=1, 2, . . . , 64); the bias terminals of the eight column units are connected, and connection terminals thereof serve as the bias terminals of the PUF array; the output terminals of the eight column units serve as eight output terminals of the PUF array.

Further, each transmission gate array comprises eight transmission gates, each transmission gate has a control terminal, an input terminal and an output terminal, the control terminals of the eight transmission gates serve as eight selection terminals of the transmission gate array, and the input terminals of the eight transmission gates serve as eight input terminals of the transmission gate array, wherein the control terminal of the k-th transmission gate serves as the k-th selection terminal of the transmission gate array (k=1, 2, . . . , 8), the input terminal of the k-th transmission gate is the k-th input terminal of the transmission gate array, and the output terminals of the eight transmission gates are connected, and connection terminals thereof serve as the output terminals of the transmission gate array.

Furthermore, each transmission gate comprises a first inverter, a second NMOS transistor and a first PMOS (P-type Metal-Oxide-Semiconductor) transistor; a gate terminal of the second NMOS transistor is connected to an input terminal of the first inverter and a connection terminal thereof serves as a control terminal of the transmission gate; a gate terminal of the first PMOS transistor is connected to an output terminal of the first inverter; a source terminal of the second NMOS transistor is connected to a drain terminal of the first PMOS transistor, and the connection terminal thereof serves as an output terminal of the transmission gate; a drain terminal of the second NMOS transistor is connected to the source terminal of the first PMOS transistor, and the connection terminal thereof serves as an input terminal of the transmission gate.

Further, the shared head comprises a cross-coupling structure, a sense amplifier and an arbitrator, wherein the cross-coupling structure has three input terminals, and the three input terminals are respectively designated first input terminal, second input terminal and third input terminal; the sense amplifier has two input terminals, one enable terminal and two output terminals, the two input terminals are respectively designated first input terminal and second input terminal, the two output terminals are respectively designated first output terminal and second output terminal; the arbitrator has two input terminals and one output terminal, the two input terminals are respectively designated first input terminal and second input terminal; the first input terminal of the cross-coupling structure is connected to the first input terminal of the sense amplifier, and the connection terminal thereof serves as the first input terminal of the shared head; the third input terminal of the cross-coupling structure is connected to the second input terminal of the sense amplifier, and the connection terminal thereof serves as the second input terminal of the shared head; the second input terminal of the cross-coupling structure serves as the pre-charge terminal of the shared head; a pre-charge signal input into the pre-charge terminal of the shared head is used to control the cross-coupling structure to enter a working state; the first output terminal of the sense amplifier is connected to the first input terminal of the arbitrator, and the second output terminal of the sense amplifier is connected to the second input terminal of the arbitrator; the enable terminal of the sense amplifier serves as the enable terminal of the shared head, and an enable signal input into the enable terminal of the shared head is used to control the sense amplifier to enter a working state; the output terminal of the arbitrator serves as the output terminal of the shared head.

Further, the cross-coupling structure comprises a second PMOS transistor, a third PMOS transistor, a fourth PMOS transistor and a fifth PMOS transistor; a gate terminal of the second PMOS transistor is connected to a gate terminal of the fifth PMOS transistor, and the connection terminal thereof serves as the second input terminal of the cross-coupling structure; a source terminal of the second PMOS transistor, a source terminal of the third PMOS transistor, a source terminal of the fourth PMOS transistor and a source terminal of the fifth PMOS transistor are all connected to supply voltage VDD; a drain terminal of the second PMOS transistor, a drain terminal of the third PMOS transistor and a gate terminal of the fourth PMOS transistor are connected, and the connection terminal thereof serves as the first input terminal of the cross-coupling structure, and a drain terminal of the fourth PMOS transistor, a drain terminal of the fifth PMOS transistor and a gate terminal of the third PMOS transistor are connected, and the connection terminal thereof serve as the third input terminal of the cross-coupling structure.

Further, the sense amplifier structure comprises a sixth PMOS transistor, a seventh PMOS transistor, an eighth PMOS transistor, a ninth PMOS transistor, a tenth PMOS transistor, an eleventh PMOS transistor, a third NMOS transistor, a fourth NMOS transistor, a fifth NMOS transistor, a sixth NMOS transistor and a seventh NMOS transistor; a source terminal of the sixth PMOS transistor, a source terminal of the seventh PMOS transistor, a source terminal of the eighth PMOS transistor, a source terminal of the ninth PMOS transistor, a source terminal of the tenth PMOS transistor and a source terminal of the eleventh PMOS transistor are all connected to the supply voltage VDD; a gate terminal of the sixth PMOS transistor, a gate terminal of the tenth PMOS transistor, a gate terminal of the seventh NMOS transistor, a gate terminal of the ninth PMOS transistor and a gate terminal of the eleventh PMOS transistor are connected, and the connection terminal thereof serves as the enable terminal of the sense amplifier; a gate terminal of the fifth NMOS transistor serves as the first input terminal of the sense amplifier; a gate terminal of the sixth NMOS transistor serves the second input terminal of the sense amplifier; a drain terminal of the sixth PMOS transistor, a drain terminal of the seventh PMOS transistor, a gate terminal of the eighth PMOS transistor, a drain terminal of the third NMOS transistor and a gate terminal of the fourth NMOS transistor are connected, and the connection terminal thereof serves as the first output terminal of the sense amplifier; a drain terminal of the eighth PMOS transistor, a drain terminal of the ninth PMOS transistor, a gate terminal of the seventh PMOS transistor, a drain terminal of the fourth NMOS transistor and a gate terminal of the third NMOS transistor are connected, and the connection terminal thereof serves as the second output terminal of the sense amplifier; a drain terminal of the tenth PMOS transistor, a source terminal of the third NMOS transistor and a drain terminal of the fifth NMOS transistor are connected; a drain terminal of the eleventh PMOS transistor, a source terminal of the fourth NMOS transistor and a drain terminal of the sixth NMOS transistor are connected; a source terminal of the fifth NMOS transistor, a source terminal of the sixth NMOS transistor and a drain terminal of the seventh NMOS transistor are connected, and a source terminal of the seventh NMOS transistor is grounded (i.e. is connected to a ground voltage).

Further, the arbitrator comprises two two-input NAND gates, each two-input NAND gate has a first input terminal, a second input terminal and an output terminal, and the two two-input NAND gates are respectively designated first two-input NAND gate and second two-input NAND gate; the first input terminal of the first two-input NAND gate serves as the first input terminal of the arbitrator unit, the second input terminal of the second two-input NAND gate serves as the second input terminal of the arbitrator unit, the second input terminal of the first two-input NAND gate is connected to the output terminal of the second two-input NAND gate, the output terminal of the first two-input NAND gate is connected to the first input terminal of the second two-input NAND gate, and the connection terminal thereof serves as the output terminal of the arbitrator unit.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a structural diagram of a current mode weak-PUF circuit with rich challenge-response pairs according to the present disclosure.

FIG. 2 is a structural diagram of a PUF array in the current mode weak-PUF circuit with rich challenge-response pairs according to the present disclosure.

FIG. 3 is a structural diagram of a column unit in the current mode weak-PUF circuit with rich challenge-response pairs according to the present disclosure.

FIG. 4 is a circuit diagram of a NMOS unit in the current mode weak-PUF circuit with rich challenge-response pairs according to the present disclosure.

FIG. 5 is a structural diagram of a transmission gate array in the current mode weak-PUF circuit with rich challenge-response pairs according to the present disclosure.

FIG. 6 is a circuit diagram of a transmission gate in the current mode weak-PUF circuit with rich challenge-response pairs according to the present disclosure.

FIG. 7 is a structural diagram of a shared head in the current mode weak-PUF circuit with rich challenge-response pairs according to the present disclosure.

FIG. 8 is a circuit diagram of a cross-coupling structure in the current mode weak-PUF circuit with rich challenge-response pairs according to the present disclosure.

FIG. 9 is a structural diagram of a sense amplifier in the current mode weak-PUF circuit with rich challenge-response pairs according to the present disclosure.

FIG. 10 is a circuit diagram of an arbitrator in the current mode weak-PUF circuit with rich challenge-response pairs according to the present disclosure.

FIG. 11 is a layout of the current mode weak-PUF circuit with rich challenge-response pairs according to the present disclosure.

FIG. 12 shows the PUF stability and randomness of the current mode weak-PUF circuit with rich challenge-response pairs according to the present disclosure under different VBB values

FIG. 13 is a grayscale image of output responses of the current mode weak-PUF circuit with rich challenge-response pairs according to the present disclosure.

FIG. 14 is an average grayscale image of output responses of the current mode weak-PUF circuit with rich challenge-response pairs according to the present disclosure.

FIG. 15 is a test diagram of intra-chip Hamming distance and inter-chip Hamming distance of the current mode weak-PUF circuit with rich challenge-response pairs according to the present disclosure.

### DESCRIPTION OF THE EMBODIMENTS

The present disclosure is further described below in conjunction with accompanying drawings and embodiments.

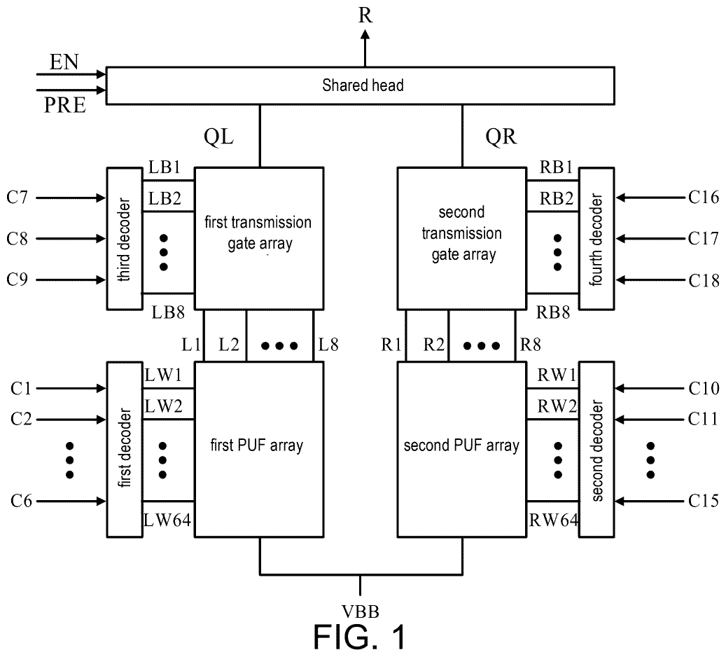

Embodiment 1: As shown in FIG. 1, a current mode weak-PUF circuit with rich challenge-response pairs, comprising a first decoder, a second decoder, a third decoder, a fourth decoder, two PUF arrays, two transmission gate arrays and one shared head, wherein each PUF array comprises 2^{q} column units (q is an integer greater than 1), each column unit comprises 2^{p} NMOS units (p is an integer greater than 1), each NMOS unit comprises an NMOS transistor, the two PUF arrays are designated first PUF array and second PUF array respectively, and the two transmission gate arrays are designated first transmission gate array and second transmission gate array respectively; the first decoder is used to access first p (p-bit) challenge signals in one set, decode the challenge signals into 2^{p} row selection signals, and output the row selection signals to the first PUF array; the first PUF array is controlled by the 2^{p} row selection signals, one NMOS unit in each column unit of the first PUF array is selected and turned on to work in a subthreshold region to generate one response and output the one response to the first transmission gate array, that is, the first PUF array generates and outputs 2^{q} responses to the first transmission gate array; the second decoder is used to access second p (p-bit) challenge signals in one set, decode the challenge signals into 2p row selection signals and output the row selection signals to the second PUF array; the second PUF array is controlled by the 2^{p} row selection signals, one NMOS unit in each column unit of the second PUF array is selected and turned on to generate one response and output the one response to the second transmission gate array, that is, the second PUF array generates and outputs 2^{q} responses to the second transmission gate array; the third decoder is used to access first q (q-bit) challenge signals in one set and decode the challenge signals into 2q selection signals and output the 2^{q} selection signals to the first transmission gate array; the fourth decoder is used to access second q (q-bit) challenge signals and decode the challenge signals into 2q selection signals and output the 2^{q} selection signals to the second transmission gate array; the first transmission gate array is

controlled by the 2q selection signals output by the third decoder, the first transmission gate array is used to select one of the 2^{q} responses output thereto by the first PUF array and output the one response to the shared header; the second transmission gate array is controlled by the 2^{q} selection signals output by the fourth decoder, the second transmission gate array is used to select one of the 2^{q} responses output thereto by the second PUF array and output the one response to the shared header; the shared header is used to compare the one response QL output thereto by the first

transmission gate array with the one response QR output thereto by the second transmission gate array, and generate and output a final PUF response according to a comparison result.

Further, p=6, q=3; the first decoder and the second decoder each have six input terminals and 64 output terminals, the third decoder and the fourth decoder each have three input terminals and eight output terminals, each of the transmission gate arrays has eight input terminals, eight selection terminals and one output terminal, each of the PUF arrays has 64 input terminals, one bias terminal and eight output terminals, and the shared head has one enable terminal, one pre-charge terminal, 2 input terminals and one output terminal; the 64 output terminals of the first decoder are connected one-to-one with the 64 input terminals of the first PUF array, the 64 output terminals of the second decoder are connected one-to-one with the 64 input terminals of the second PUF array, the bias terminal of the first PUF array is connected to the bias terminal of the second PUF array, and the connection terminal thereof serves as a bias terminal of the current mode weak-PUF circuit with rich challenge-response pairs and is used to access a bias signal VBB, and the bias signal VBB is used to allow the NMOS transistors in the first PUF array and the second PUF array to work in the subthreshold region; the eight output terminals of the third decoder are connected one-to-one with the eight selection terminals of the first transmission gate array, the eight output terminals of the first PUF array are connected one-to-one with the eight input terminals of the first transmission gate array, the eight output terminals of the fourth decoder are connected one-to-one with the eight selection terminals of the second transmission gate array, the eight output terminals of the second PUF array are connected one-to-one with the eight input terminals of the second transmission gate array, and the output terminals of the first transmission gate array and the output terminals of the second transmission gate array are connected one-to-one with the two input terminals of the shared header; the six input terminals of the first decoder, the three input terminals of the third decoder, the six input terminals of the second decoder and the three input terminals of the fourth decoder constitute 18 challenge terminals of the current mode weak-PUF circuit with rich challenge-response pairs, and the 18 challenge terminals are used to access 18 challenge signals C1 to C18; the enable terminal of the shared head serves as an enable terminal of the current mode weak-PUF circuit with rich challenge-response pairs and is used to access an enable signal EN, and the pre-charge terminal of the shared head serves as a pre-charge terminal of the current mode weak-PUF circuit with rich challenge-response pairs and is used to access a pre-charge signal PRE.

In this embodiment, by using first p challenge signals in one set and second p challenge signals in one set, the same or different, and first q challenge signals in one set and second q challenge signals in one set, the same or different, under the decoding action of the first decoder and the third decoder on the challenge signals input thereto and under the decoding action of the second decoder and the fourth decoder on the challenge signals input thereto, a certain NMOS unit in a certain column unit in the first PUF array can perform comparison with any NMOS unit in any column unit in the second PUF array, so as to output a final response (signal); that is, when there are 2^{q} column units in each of the first PUF array and the second PUF array, and 2^{p} NMOS units in each column unit, the number of CRPs generated by the current mode weak-PUF circuit with rich challenge-response pairs according the present disclosure is (2^{p+q})². The conventional weak PUF circuit can only perform comparison between the NMOS units at the same position in the column units at the same position in the first PUF array and the second PUF array to output a response. That is, when a convention weak PUF circuit has 2^{q} column units in each of the first and second PUF arrays thereof and each column unit has 2^{p} NMOS units, the convention weak PUF circuit can generate 2^{p+q} CRPs. In view of this, when a convention weak PUF circuit also has two PUF arrays and the two PUF arrays are exactly the same as the two PUF arrays in the current mode weak-PUF circuit with rich challenge-response pairs of the present disclosure, the current mode weak-PUF circuit with rich challenge-response pairs of the present disclosure increases the number of CRPs from 2^{p+q} to (2^{p+q})² and also increase the PUF entropy utilization rate by 2^{p+q} times, as compared with the conventional weak PUF circuit. Given that, the current mode weak-PUF circuit with rich challenge-response pairs according to the present disclosure can significantly increase the number of CRPs with less hardware overhead.

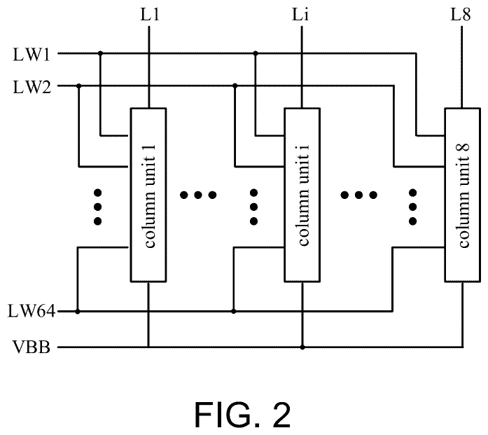

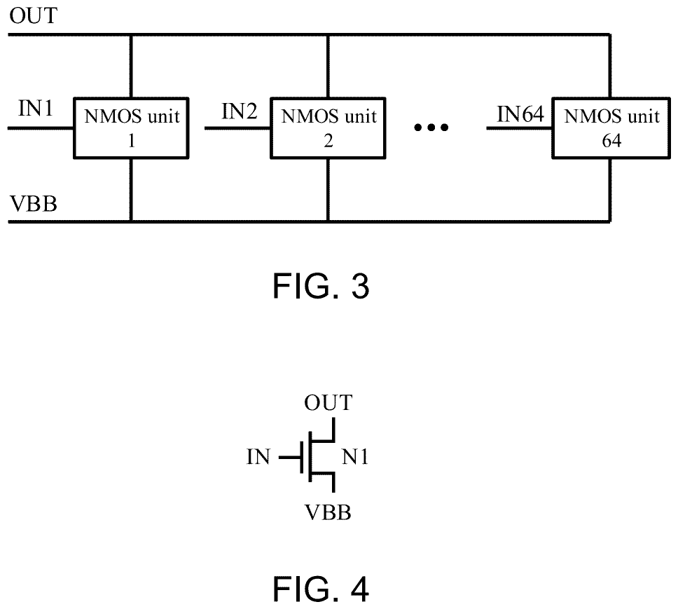

Embodiment 2: This embodiment is basically the same as Embodiment 1 but differs in the following way: in this embodiment, as shown in FIGS. 2-4, in each PUF array, each column unit has 64 input terminals, bias terminals and output terminals, and in each column unit, each NMOS unit has an input terminal, a bias terminal and an output terminal; the NMOS transistor of each NMOS unit is designated first NMOS transistor N1, a gate terminal of the first NMOS serves as the input terminal of the NMOS unit, a drain terminal of the first NMOS serves as the bias terminal of the NMOS unit, a source terminal of the first NMOS serves as the output terminal of the NMOS unit, and the input terminal of the j-th NMOS unit is the j-th input terminal of the column unit (j=1, 2, . . . , 64); the bias terminals of 64 NMOS units are connected, and the connection terminals thereof serve as the bias terminals of the column unit; the output terminals of 64 NMOS units are connected, and the connection terminals thereof serve as the output terminals of the column units; i-th input terminals of the eight column units are connected, and the connection terminals thereof serve as the i-th input terminals of the PUF array (i=1, 2, . . . , 64); the bias terminals of the eight column units are connected, and the connection terminals thereof serve as the bias terminals of the PUF array; the output terminals of the eight column units serve as eight output terminals of the PUF array.

In this embodiment, in each PUF array, when the input terminal of a certain NMOS unit in a certain column unit receives a high voltage level, in the NMOS unit, the first NMOS transistor N1 operates in a subthreshold region under the action of the bias voltage VBB connected to the drain thereof, and the first NMOS transistor N1 generates a corresponding voltage signal and outputs the voltage signal at the source thereof, and the voltage signal is the extracted process deviation between transistors. In the first PUF array, according to 64 row selection signals decoded by the first decoder, one of the NMOS units in the first PUF array is selected to be turned on. Since the bias terminals of all NMOS units in the first PUF array are connected together, it can ensure that all NMOS transistors therein operate in the subthreshold region, thereby amplifying the process deviation in the manufacturing process of the NMOS transistors. In the meanwhile, in the second PUF array, according to 64 row selection signals decoded by the second decoder, one of the NMOS units in the second PUF array is selected to be turned on. Since the bias terminals of all NMOS units in the second PUF array are connected together, it can ensure that all NMOS transistors therein operate in the subthreshold region, thereby amplifying the process deviation in the manufacturing process of the NMOS transistors. In this way, the stability of the current mode weak-PUF circuit with rich challenge-response pairs according to the present disclosure can be improved.

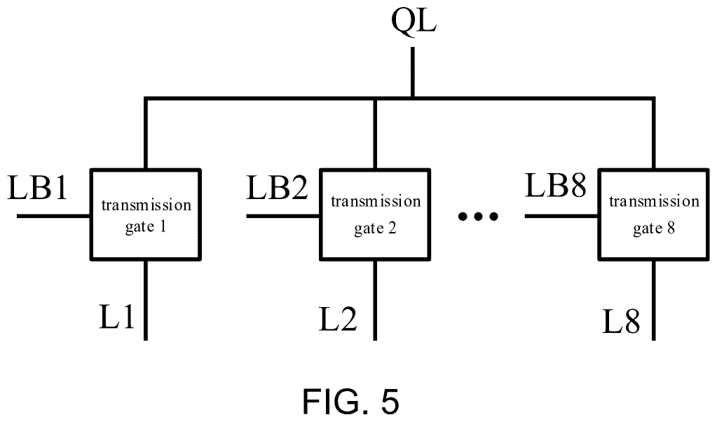

Embodiment 3: This embodiment is basically the same as Embodiment 2 but differs in the following way: in this embodiment, as shown in FIG. 5, each transmission gate array comprises eight transmission gates, each transmission gate has a control terminal, an input terminal and an output terminal, the control terminals of the eight transmission gates serve as eight selection terminals of the transmission gate array, and the input terminals of the eight transmission gates serve as eight input terminals of the transmission gate array, wherein the control terminal of the k-th transmission gate serves as the k-th selection terminal of the transmission gate array (k=1, 2, . . . , 8), the input terminal of the k-th transmission gate is the k-th input terminal of the transmission gate array, and the output terminals of the eight transmission gates are connected, and the connection terminals thereof serve as the output terminals of the transmission gate array.

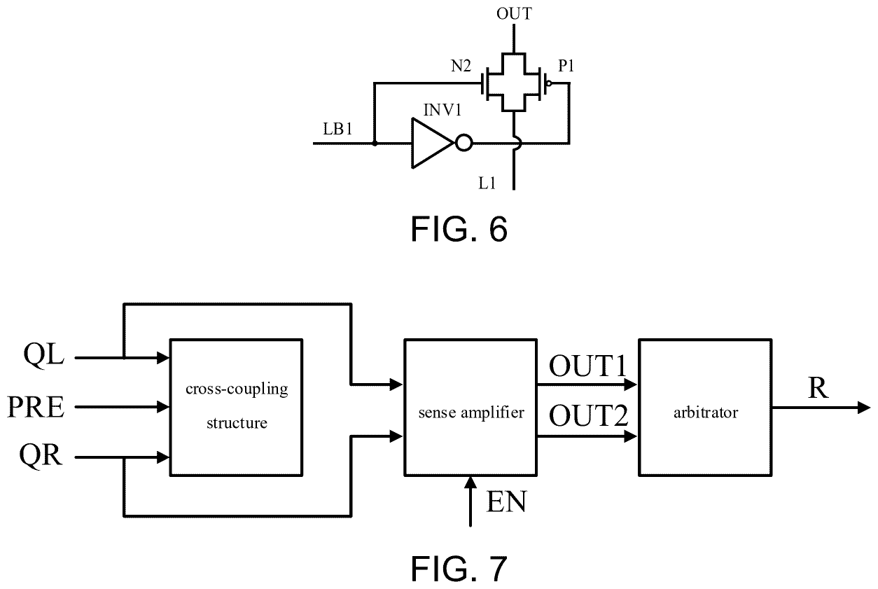

In this embodiment, as shown in FIG. 6, each transmission gate comprises a first inverter INV1, a second NMOS transistor N2 and a first PMOS transistor P1; a gate terminal of the second NMOS transistor N2 is connected to an input terminal of the first inverter INV1 and the connection terminal thereof serves as a control terminal of the transmission gate; a gate terminal of the first PMOS transistor P1 is connected to an output terminal of the first inverter INV1; a source terminal of the second NMOS transistor N2 is connected to a drain terminal of the first PMOS transistor P1, and the connection terminal thereof serves as an output terminal of the transmission gate; a drain terminal of the second NMOS transistor N2 is connected to the source terminal of the first PMOS transistor P1, and the connection terminal thereof serves as an input terminal of the transmission gate.

In this embodiment, when the control terminal of the transmission gate receives a high voltage level 1, the second NMOS transistor N2 and the first PMOS transistor P1 are both turned on. In this case, the transmission gate is in an ON state, and a signal input to the input terminal of the transmission gate is transmitted via the second NMOS transistor N2 and the first PMOS transistor P1 to the output terminal of the transmission gate and then output. When the control terminal of the transmission gate receives a low voltage level 0, the second NMOS transistor N2 and the first PMOS transistor P1 are both turned off and in this case, the transmission gate is in an OFF state and cannot transmit the signal input to the input terminal thereof to the output terminal thereof.

Embodiment 4: This embodiment is basically the same as Embodiment 3 but differs in the following way: in this embodiment, as shown in FIG. 7, the shared head comprises a cross-coupling structure, a sense amplifier and an arbitrator, wherein the cross-coupling structure has three input terminals, and the three input terminals are respectively designated first input terminal, second input terminal and third input terminal; the sense amplifier has two input terminals, one enable terminal and two output terminals, the two input terminals are respectively designated first input terminal and second input terminal, the two output terminals are respectively designated first output terminal and second output terminal; the arbitrator has two input terminals and one output terminal, the two input terminals are respectively designated first input terminal and second input terminal; the first input terminal of the cross-coupling structure is connected to the first input terminal of the sense amplifier, and the connection terminal thereof serves as the first input terminal of the shared head; the third input terminal of the cross-coupling structure is connected to the second input terminal of the sense amplifier, and the connection terminal thereof serves as the second input terminal of the shared head; the second input terminal of the cross-coupling structure serves as the pre-charge terminal of the shared head; a pre-charge signal PRE input into the pre-charge terminal of the shared head is used to control the cross-coupling structure to enter a working state; the first output terminal of the sense amplifier is connected to the first input terminal of the arbitrator, and the second output terminal of the sense amplifier is connected to the second input terminal of the arbitrator; the enable terminal of the sense amplifier serves as the enable terminal of the shared head, and an enable signal input into the enable terminal of the shared head is used to control the sense amplifier to enter a working state; the output terminal of the arbitrator serves as the output terminal of the shared head.

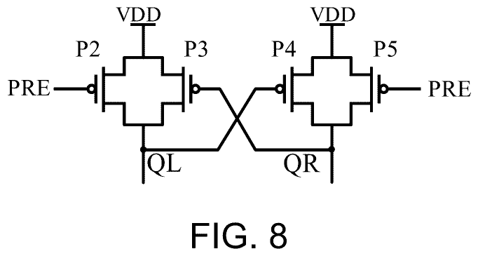

In this embodiment, as shown in FIG. 8, the cross-coupling structure comprises a second PMOS transistor P2, a third PMOS transistor P3, a fourth PMOS transistor P4 and a fifth PMOS transistor P5; a gate terminal of the second PMOS transistor P2 is connected to a gate terminal of the fifth PMOS transistor P5, and the connection terminal thereof serves as the second input terminal of the cross-coupling structure; a source terminal of the second PMOS transistor P2, a source terminal of the third PMOS transistor P3, a source terminal of the fourth PMOS transistor P4 and a source terminal of the fifth PMOS transistor P5 are all connected to supply voltage VDD; a drain terminal of the second PMOS transistor P2, a drain terminal of the third PMOS transistor P3 and a gate terminal of the fourth PMOS transistor P4 are connected, and the connection terminal thereof serves as the first input terminal of the cross-coupling structure, and a drain terminal of the fourth PMOS transistor P4, a drain terminal of the fifth PMOS transistor P5 and a gate terminal of the third PMOS transistor P3 are connected, and the connection terminal thereof serve as the third input terminal of the cross-coupling structure.

In this cross-coupling structure, when the pre-charge signal PRE input into the second input terminal is at a low voltage level 0, the second PMOS transistor P2 and the fifth PMOS transistor P5 are both turned on and in this case, the signals input into the first input terminal and the second input terminal are pulled to be equal to the supply voltage VDD, and the third PMOS transistor P3 and the fourth PMOS transistor P4 are both turned off. When the pre-charge signal PRE input into the second input terminal is at a high voltage level 1, the second PMOS transistor P2 and the fifth PMOS transistor P5 are both turned off and in this case, the leakage currents connected to the first input terminal and the third input terminal are determined. If the leakage current connected to the first input terminal is greater than the leakage current connected to the third input terminal, the fourth PMOS transistor P4 is turned on, the signal input into the first input terminal is pulled to the supply voltage VDD, and the third PMOS transistor P3 pulls the signal input into the third input terminal to be equal to the bias voltage VBB. If the leakage current connected to the first input terminal is less than the leakage current connected to the third input terminal, the third PMOS transistor P3 is turned on, the signal input into the third input terminal is pulled to the supply voltage VDD, and the fourth PMOS transistor P4 pulls the signal input into the third input terminal to be equal to the bias voltage VBB. Since each PMOS transistor has process deviation during manufacturing, the leakage currents at the first input terminal and the third input terminal of the cross-coupling structure may not be equal.

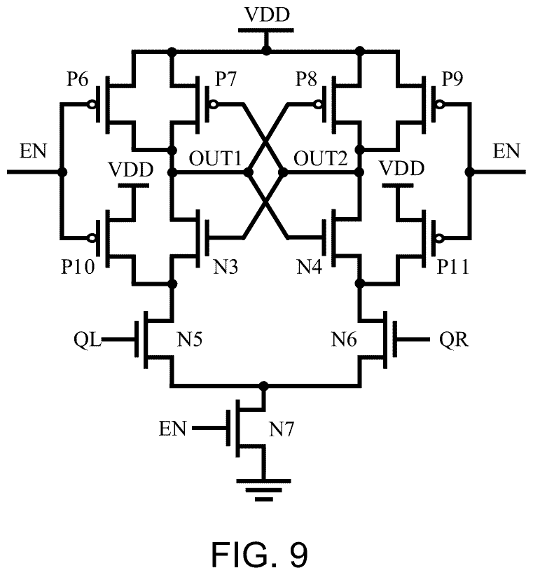

In this embodiment, as shown in FIG. 9, the sense amplifier structure comprises a sixth PMOS transistor P6, a seventh PMOS transistor P7, an eighth PMOS transistor P8, a ninth PMOS transistor P9, a tenth PMOS transistor 10, an eleventh PMOS transistor P11, a third NMOS transistor N3, a fourth NMOS transistor N4, a fifth NMOS transistor N5, a sixth NMOS transistor N6 and a seventh NMOS transistor N7; a source terminal of the sixth PMOS transistor P6, a source terminal of the seventh PMOS transistor N7, a source terminal of the eighth PMOS transistor N8, a source terminal of the ninth PMOS transistor N9, a source terminal of the tenth PMOS transistor N10 and a source terminal of the eleventh PMOS transistor N 11 are all connected to the supply voltage VDD; a gate terminal of the sixth PMOS transistor P6, a gate terminal of the tenth PMOS transistor P10, a gate terminal of the seventh NMOS transistor N7, a gate terminal of the ninth PMOS transistor P9 and a gate terminal of the eleventh PMOS transistor P11 are connected, and the connection terminal thereof serves as the enable terminal of the sense amplifier; a gate terminal of the fifth NMOS transistor N5 serves as the first input terminal of the sense amplifier; a gate terminal of the sixth NMOS transistor N6 serves the second input terminal of the sense amplifier; a drain terminal of the sixth PMOS transistor P6, a drain terminal of the seventh PMOS transistor P7, a gate terminal of the eighth PMOS transistor P8, a drain terminal of the third NMOS transistor N3 and a gate terminal of the fourth NMOS transistor N4 are connected, and the connection terminal thereof serves as the first output terminal of the sense amplifier; a drain terminal of the eighth PMOS transistor P8, a drain terminal of the ninth PMOS transistor P9, a gate terminal of the seventh PMOS transistor P7, a drain terminal of the fourth NMOS transistor N4 and a gate terminal of the third NMOS transistor N4 are connected, and the connection terminal thereof serves as the second output terminal of the sense amplifier; a drain terminal of the tenth PMOS transistor P10, a source terminal of the third NMOS transistor N3 and a drain terminal of the fifth NMOS transistor N5 are connected; a drain terminal of the eleventh PMOS transistor P11, a source terminal of the fourth NMOS transistor N4 and a drain terminal of the sixth NMOS transistor N6 are connected; a source terminal of the fifth NMOS transistor N5, a source terminal of the sixth NMOS transistor N6 and a drain terminal of the seventh NMOS transistor N7 are connected, and a source terminal of the seventh NMOS transistor N7 is grounded.

In the sense amplifier, when the enable signal input into the enable terminal of the sense amplifier is at a low voltage level 0, the sense amplifier is in a pre-charging state, the sixth PMOS transistor P6, the tenth PMOS transistor P10, the ninth PMOS transistor P9 and the eleventh PMOS transistor P11 are all turned on, the seventh NMOS transistor N7, the seventh PMOS transistor P7, the eighth PMOS, the third NMOS and the fourth NMOS are all turned off, and the fifth NMOS and the sixth NMOS are turned on or off according to the corresponding gate voltages. Since the sixth PMOS transistor P6 is turned on, the first output terminal of the sense amplifier is charged to a high voltage level, and since the ninth PMOS transistor P9 is turned on, the second output terminal of the sense amplifier is also charged to a high voltage level. When the enable signal input into the enable terminal of the sense amplifier is at a high voltage level 1, the sense amplifier is in an evaluation state, the sixth PMOS transistor P6, the tenth PMOS transistor P10, the ninth PMOS transistor P9 and the eleventh PMOS transistor P11 are all turned off, and the seventh NMOS transistor N7 is turned on. When the input signal of the first input terminal of the sense amplifier is VBB and the signal of the second input terminal is VDD, the sixth NMOS transistor N6 is turned on more quickly than the fifth NMOS transistor N5, and the discharge speed of the second output terminal of the sense amplifier is higher than the discharge speed of the first output terminal of the sense amplifier. Finally, the first output terminal of the sense amplifier outputs a high voltage level and the second output terminal outputs a low voltage level. When the input signal of the first input terminal of the sense amplifier is VDD and the signal of the second input terminal is VBB, the fifth NMOS transistor N5 is turned on more quickly than the sixth NMOS transistor N6, and the discharge speed of the first output terminal of the sense amplifier is higher than the discharge speed of the second output terminal of the sense amplifier. Finally, the second output terminal of the sense amplifier outputs a high voltage level and the first output terminal outputs a low voltage level.

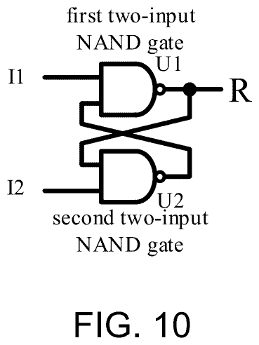

In this embodiment, as shown in FIG. 10, the arbitrator comprises two two-input NAND gates, each two-input NAND gate has a first input terminal, a second input terminal and an output terminal, and the two two-input NAND gates are respectively designated first two-input NAND gate U1 and second two-input NAND gate U2; the first input terminal of the first two-input NAND gate U1 serves as the first input terminal of the arbitrator unit, the second input terminal of the second two-input NAND gate U2 serves as the second input terminal of the arbitrator unit, the second input terminal of the first two-input NAND gate U1 is connected to the output terminal of the second two-input NAND gate U2, the output terminal of the first two-input NAND gate U1 is connected to the first input terminal of the second two-input NAND gate U2, and the connection terminal thereof serves as the output terminal of the arbitrator unit.

In the arbitrator, when the signal input into the first input terminal of the first two-input NAND gate U1 is at a low voltage level, and the signal input into the second input terminal of the second two-input NAND gate U2 is at a low voltage level, no matter whether the signal input into the second input terminal of the first two-input NAND gate U1 is at a high voltage level or a low voltage level, and no matter whether the signal input into the first input terminal of the second two-input NAND gate U2 is at a high voltage level or a low voltage level, the signal outputted by the output terminal of the arbitrator is at a high voltage level. When the signal input into the first input terminal of the first two-input NAND gate U1 is at a high voltage level, and the signal input into the second input terminal of the second two-input NAND gate U2 is at a high voltage level, the signal outputted by the output terminal of the arbitrator remains unchanged in the previous state. When the signal input into the first input terminal of the first two-input NAND gate U1 is at a high voltage level, and the signal input into the second input terminal of the second two-input NAND gate U2 is at low voltage level, no matter whether the signal input into the first input terminal of the second two-input NAND gate U2 is at a high voltage level or a low voltage level, the signal outputted from the output terminal of the second two-input NAND gate U2 is at a high voltage level, and in this case, the signal input into the second input terminal of the first two-input NAND gate U1 is also at a high voltage level, and finally the signal outputted from the output terminal of the arbitrator is at a low voltage level. When the signal input into the first input terminal of the first two-input NAND gate U1 is at a low voltage level and the signal input into the second input terminal of the second two-input NAND gate U2 is at a high voltage level, no matter whether the signal input into the second input terminal of the first two-input NAND gate U1 is at a high voltage level or a low voltage level, the signal outputted by the output terminal of the arbitrator is at a high voltage level, then the signal input into the first input terminal of the second two-input NAND gate U2 is also at a high voltage level, and the signal outputted by the output terminal of the second two-input NAND gate U2 is at a low voltage level.

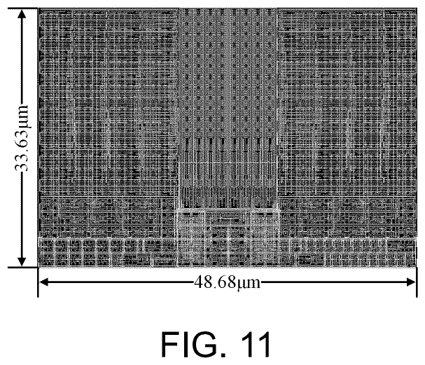

In order to verify the performance of the current mode weak-PUF circuit with rich challenge-response pairs according to the present disclosure, the current mode weak-PUF circuit with rich challenge-response pairs is implemented by using TSMC 65 nm CMOS process, and its layout is shown in FIG. 11. When p=6 and q=3, the overall layout area of the current mode weak-PUF circuit with rich challenge-response pairs according to the present invention is 33.63 μm×48.68 μm, with less hardware overhead.

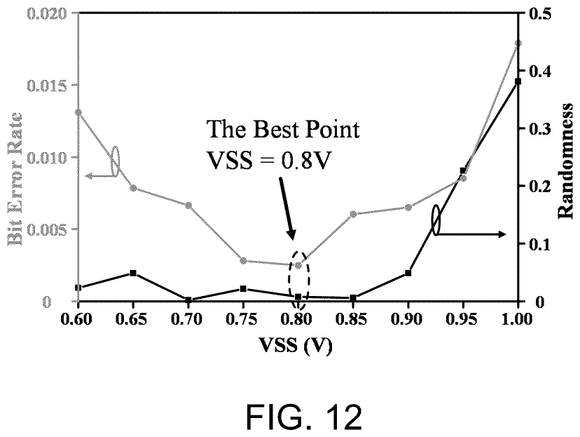

In order to verify the value of the bias voltage VBB input by the entropy source transistor (i.e., the first NMOS transistor in the NMOS unit of the column unit) of the PUF array when the current mode weak-PUF circuit with rich challenge-response pairs works at the best performance, the entropy source transistor of the PUF array was tested for its performance indicators when a 0.6V-1V voltage level is applied to the source. That is, the test was performed with the bias voltage VBB being 0.6V, 0.65V, 0.7V, 0.75V, 0.8V, 0.85V, 0.9V, 0.95V and 1V. The test results are shown in FIG. 12. When the bias voltage VBB increased from 0.6V to 0.8V, the same challenge-response pair was tested 50 times repeatedly, and the average bit error rate (BER) dropped from 1.31% to 0.25%, with a decrease of 5.24 times. When the bias voltage VBB decreased from 1V to 0.8V, the same challenge-response pair was tested 50 times repeatedly, and the average BER dropped from 1.78% to 0.25% with a decrease of 7.12 times, and the randomness at 0.8V was also good. In view of this, the current mode weak-PUF circuit with rich challenge-response pairs according to the present disclosure has good stability and randomness when the bias voltage VBB is 0.8V.

Randomness indicates whether the PUF output responses are randomly distributed and can be intuitively reflected by a grayscale image. For a real sample of the current mode weak-PUF circuit with rich challenge-response pairs according to the present disclosure, with the bias voltage VBB of 0.8V, 8192 CRPs were randomly extracted. The obtained grayscale image is shown in FIG. 13. With reference to FIG. 13, the probability of the response being “1” is 50.01%, and the probability of the response being “0” is 49.99%, indicating that the current mode weak-PUF circuit with rich challenge-response pairs according to the present disclosure has good randomness.

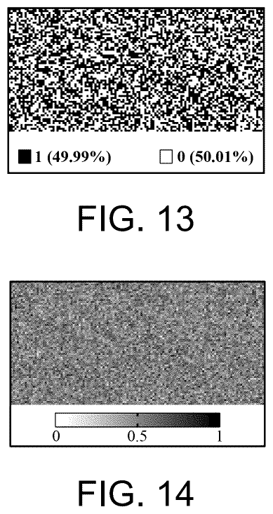

In addition, 20 real samples of the current mode weak-PUF circuit with rich challenge-response pairs according to the present disclosure were repeatedly tested. With the bias voltage VBB of 0.8, 8192 CRPs were randomly extracted from each real sample of the current mode weak-PUF circuit with rich challenge-response pairs. The obtained average grayscale image is shown in FIG. 14. With reference to FIG. 14, the probability of the response being “1” is 49.86%, and the probability of the response being “0” is 50.14%, indicating that the current mode weak-PUF circuit with rich challenge-response pairs according to the present disclosure has good randomness.

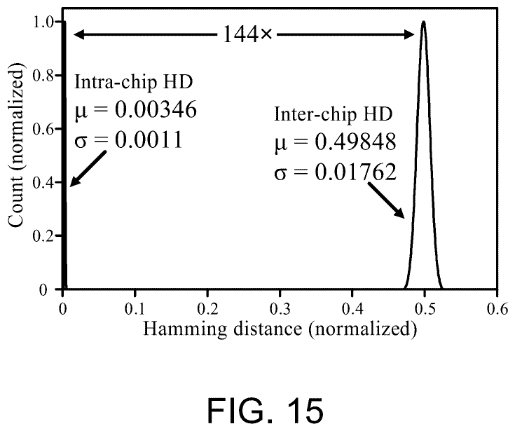

Uniqueness indicates the ability to distinguish different PUFs. Under the same challenge, the output responses of multiple real samples of the current mode weak-PUF circuit with rich challenge-response pairs according to the present disclosure were repeatedly tested with the bias voltage VBB of 0.8V, and the inter-chip Hamming distance was used for measurement. The test results of the intra-chip Hamming distance and inter-chip Hamming distance of the current mode weak-PUF circuit with rich challenge-response pairs according to the present disclosure are shown in FIG. 15. With reference to FIG. 15, the expected value of the inter-chip Hamming distance is 49.848% and the standard deviation is 1.762%. Both are close to the expected ideal value of 50% and the expected ideal standard deviation of 0%, indicating that the current mode weak-PUF circuit with rich challenge-response pairs according to the present disclosure has good uniqueness.

To sum up, by using the NMOS transistor working in the subthreshold region as an entropy source, the current mode weak-PUF circuit with rich challenge-response pairs according to the present disclosure amplifies the process deviation in the manufacturing process, improves the stability of the PUF. In addition, based on a one-to-many configuration of entropy sources, the number of CRPs is increased from 2^{p+q} to (2^{p+q})² and the PUF entropy utilization rate is improved by 2^{p+q} times. The number of CRPs is significantly increased with less hardware overhead. Moreover, the current mode weak-PUF circuit with rich challenge-response pairs has good randomness and uniqueness.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A current mode weak-PUF circuit with rich challenge-response pairs, comprising a first decoder, a second decoder, a third decoder, a fourth decoder, two PUF arrays, two transmission gate arrays and one shared head, wherein each PUF array comprises 2^{q} column units, q is an integer greater than 1, each column unit comprises 2^{p} NMOS units, p is an integer greater than 1, each NMOS unit comprises an NMOS transistor, the two PUF arrays are designated a first PUF array and a second PUF array respectively, and the two transmission gate arrays are designated a first transmission gate array and a second transmission gate array respectively; the first decoder is used to access first p challenge signals in one set, decode the first p challenge signals into 2^{p} row selection signals, and output the 2^{p} row selection signals to the first PUF array; the first PUF array is controlled by the 2^{p} row selection signals, one NMOS unit in each column unit of the first PUF array is selected and turned on to work in a subthreshold region to generate one response and output the one response to the first transmission gate array, the first PUF array generates and outputs 2^{q} responses to the first transmission gate array; the second decoder is used to access second p challenge signals in one set, decode the second p challenge signals into another 2^{p} row selection signals and output the another 2^{p} row selection signals to the second PUF array; the second PUF array is controlled by the another 2^{p} row selection signals, one NMOS unit in each column unit of the second PUF array is selected and turned on to generate another one response and output the another one response to the second transmission gate array, the second PUF array generates and outputs another 2^{q} responses to the second transmission gate array; the third decoder is used to access first q challenge signals in one set and decode the first q challenge signals into 2^{q} selection signals and output the 2^{q} selection signals to the first transmission gate array; the fourth decoder is used to access second q challenge signals and decode the second q challenge signals into another 2^{q} selection signals and output the another 2^{q} selection signals to the second transmission gate array; the first transmission gate array is controlled by the 2^{q} selection signals output by the third decoder, the first transmission gate array is used to select one of the 2^{q} responses output by the first PUF array and output the one of the 2^{q} responses to the shared header; the second transmission gate array is controlled by the 2^{q} selection signals output by the fourth decoder, the second transmission gate array is used to select one of the another 2^{q} responses output by the second PUF array and output the one of the another 2^{q} responses to the shared header; the shared header is used to compare the one of the 2^{q} responses output by the first transmission gate array with the one of the another 2^{q} responses output by the second transmission gate array, and generate and output a final PUF response according to a comparison result.

2. The current mode weak-PUF circuit with rich challenge-response pairs according to claim 1, wherein p=6, q=3; the first decoder and the second decoder each have six input terminals and 64 output terminals, the third decoder and the fourth decoder each have three input terminals and eight output terminals, each of the transmission gate arrays has eight input terminals, eight selection terminals and one output terminal, each of the PUF arrays has 64 input terminals, one bias terminal and eight output terminals, and the shared head has one enable terminal, one pre-charge terminal, 2 input terminals and one output terminal; the 64 output terminals of the first decoder are connected one-to-one with the 64 input terminals of the first PUF array, the 64 output terminals of the second decoder are connected one-to-one with the 64 input terminals of the second PUF array, the bias terminal of the first PUF array is connected to the bias terminal of the second PUF array to form a connection terminal which serves as a bias terminal of the current mode weak-PUF circuit with rich challenge-response pairs and is used to access a bias signal VBB, and the bias signal VBB is used to allow the NMOS transistors in the first PUF array and the second PUF array to work in the subthreshold region; the eight output terminals of the third decoder are connected one-to-one with the eight selection terminals of the first transmission gate array, the eight output terminals of the first PUF array are connected one-to-one with the eight input terminals of the first transmission gate array, the eight output terminals of the fourth decoder are connected one-to-one with the eight selection terminals of the second transmission gate array, the eight output terminals of the second PUF array are connected one-to-one with the eight input terminals of the second transmission gate array, and the output terminals of the first transmission gate array and the output terminals of the second transmission gate array are connected one-to-one with the two input terminals of the shared header; the six input terminals of the first decoder, the three input terminals of the third decoder, the six input terminals of the second decoder and the three input terminals of the fourth decoder constitute 18 challenge terminals of the current mode weak-PUF circuit with rich challenge-response pairs, and the 18 challenge terminals are used to access 18 challenge signals; the enable terminal of the shared head serves as an enable terminal of the current mode weak-PUF circuit with rich challenge-response pairs and is used to access an enable signal, and the pre-charge terminal of the shared head serves as a pre-charge terminal of the current mode weak-PUF circuit with rich challenge-response pairs and is used to access a pre-charge signal.

3. The current mode weak-PUF circuit with rich challenge-response pairs according to claim 2, wherein in each PUF array, each column unit has 64 input terminals, a plurality of bias terminals and a plurality of output terminals, and in each column unit, each NMOS unit has an input terminal, a bias terminal and an output terminal; the NMOS transistor of each NMOS unit is designated first NMOS transistor, a gate terminal of the first NMOS serves as the input terminal of the NMOS unit, a drain terminal of the first NMOS serves as the bias terminal of the NMOS unit, a source terminal of the first NMOS serves as the output terminal of the NMOS unit, and the input terminal of the j-th NMOS unit is the j-th input terminal of the column unit, j is a positive integer from 1 to 64 (j=1,2, . . . ,64); the plurality of bias terminals of 64 NMOS units are connected to form a plurality of connection terminals, and the plurality of connection terminals which serve as the plurality of bias terminals of the column unit; the plurality of output terminals of 64 NMOS units are connected to form a plurality of connection terminals, and the plurality of connection terminals which serve as the plurality of output terminals of the column units; the plurality of i-th input terminals of the eight column units are connected to form a plurality of connection terminals, and the plurality of connection terminals which serve as the plurality of i-th input terminals of the PUF array, i is a positive integer from 1 to 64 (i=1, 2, . . . , 64); the plurality of bias terminals of the eight column units are connected to form a plurality of connection terminals, and the plurality of connection terminals which serve as the plurality of bias terminals of the PUF array; the plurality of output terminals of the eight column units serve as eight output terminals of the PUF array.

4. The current mode weak-PUF circuit with rich challenge-response pairs according to claim 2, wherein each transmission gate array comprises eight transmission gates, each transmission gate has a control terminal, an input terminal and an output terminal, a plurality of control terminals of the eight transmission gates serve as eight selection terminals of the transmission gate array, and the plurality of input terminals of the eight transmission gates serve as eight input terminals of the transmission gate array, wherein the control terminal of the k-th transmission gate serves as the k-th selection terminal of the transmission gate array, k is a positive integer from 1 to 8(k=1 , 2, . . . , 8), the input terminal of the k-th transmission gate is the k-th input terminal of the transmission gate array, and the plurality of output terminals of the eight transmission gates are connected to form a plurality of connection terminals which serve as the plurality of output terminals of the transmission gate array.

5. The current mode weak-PUF circuit with rich challenge-response pairs according to claim 4, wherein each transmission gate comprises a first inverter, a second NMOS transistor and a first PMOS transistor; a gate terminal of the second NMOS transistor is connected to an input terminal of the first inverter and a connection terminal which serves as a control terminal of the transmission gate; a gate terminal of the first PMOS transistor is connected to an output terminal of the first inverter; a source terminal of the second NMOS transistor is connected to a drain terminal of the first PMOS transistor, and the connection terminal which serves as an output terminal of the transmission gate; a drain terminal of the second NMOS transistor is connected to the source terminal of the first PMOS transistor to form a connection terminal which serves as an input terminal of the transmission gate.

6. The current mode weak-PUF circuit with rich challenge-response pairs according to claim 2, wherein the shared head comprises a cross-coupling structure, a sense amplifier and an arbitrator, wherein the cross-coupling structure has three input terminals, and the three input terminals are respectively designated first input terminal, second input terminal and third input terminal; the sense amplifier has two input terminals, one enable terminal and two output terminals, the two input terminals are respectively designated a first input terminal and a second input terminal, the two output terminals are respectively designated a first output terminal and a second output terminal; the arbitrator has two input terminals and one output terminal, the two input terminals are respectively designated a first input terminal and a second input terminal; the first input terminal of the cross-coupling structure is connected to the first input terminal of the sense amplifier to from a the connection terminal which serves as the first input terminal of the shared head; the third input terminal of the cross-coupling structure is connected to the second input terminal of the sense amplifier to from a connection terminal which serves as the second input terminal of the shared head; the second input terminal of the cross-coupling structure serves as the pre-charge terminal of the shared head; a pre-charge signal input into the pre-charge terminal of the shared head is used to control the cross-coupling structure to enter a working state; the first output terminal of the sense amplifier is connected to the first input terminal of the arbitrator, and the second output terminal of the sense amplifier is connected to the second input terminal of the arbitrator; the enable terminal of the sense amplifier serves as the enable terminal of the shared head, and an enable signal input into the enable terminal of the shared head is used to control the sense amplifier to enter a working state; the output terminal of the arbitrator serves as the output terminal of the shared head.

7. The current mode weak-PUF circuit with rich challenge-response pairs according to claim 6, wherein the cross-coupling structure comprises a second PMOS transistor, a third PMOS transistor, a fourth PMOS transistor and a fifth PMOS transistor; a gate terminal of the second PMOS transistor is connected to a gate terminal of the fifth PMOS transistor to from a connection terminal which serves as the second input terminal of the cross-coupling structure; a source terminal of the second PMOS transistor, a source terminal of the third PMOS transistor, a source terminal of the fourth PMOS transistor and a source terminal of the fifth PMOS transistor are all connected to a supply voltage; a drain terminal of the second PMOS transistor, a drain terminal of the third PMOS transistor and a gate terminal of the fourth PMOS transistor are connected to from a connection terminal which serves as the first input terminal of the cross-coupling structure, and a drain terminal of the fourth PMOS transistor, a drain terminal of the fifth PMOS transistor and a gate terminal of the third PMOS transistor are connected to form a connection terminal which serve as the third input terminal of the cross-coupling structure.

8. The current mode weak-PUF circuit with rich challenge-response pairs according to claim 6, wherein the sense amplifier structure comprises a sixth PMOS transistor, a seventh PMOS transistor, an eighth PMOS transistor, a ninth PMOS transistor, a tenth PMOS transistor, an eleventh PMOS transistor, a third NMOS transistor, a fourth NMOS transistor, a fifth NMOS transistor, a sixth NMOS transistor and a seventh NMOS transistor; a source terminal of the sixth PMOS transistor, a source terminal of the seventh PMOS transistor, a source terminal of the eighth PMOS transistor, a source terminal of the ninth PMOS transistor, a source terminal of the tenth PMOS transistor and a source terminal of the eleventh PMOS transistor are all connected to the supply voltage; a gate terminal of the sixth PMOS transistor, a gate terminal of the tenth PMOS transistor, a gate terminal of the seventh NMOS transistor, a gate terminal of the ninth PMOS transistor and a gate terminal of the eleventh PMOS transistor are connected to form a connection terminal which serves as the enable terminal of the sense amplifier; a gate terminal of the fifth NMOS transistor serves as the first input terminal of the sense amplifier; a gate terminal of the sixth NMOS transistor serves as the second input terminal of the sense amplifier; a drain terminal of the sixth PMOS transistor, a drain terminal of the seventh PMOS transistor, a gate terminal of the eighth PMOS transistor, a drain terminal of the third NMOS transistor and a gate terminal of the fourth NMOS transistor are connected to form a connection terminal which serves as the first output terminal of the sense amplifier; a drain terminal of the eighth PMOS transistor, a drain terminal of the ninth PMOS transistor, a gate terminal of the seventh PMOS transistor, a drain terminal of the fourth NMOS transistor and a gate terminal of the third NMOS transistor are connected to form a connection terminal which serves as the second output terminal of the sense amplifier; a drain terminal of the tenth PMOS transistor, a source terminal of the third NMOS transistor and a drain terminal of the fifth NMOS transistor are connected; a drain terminal of the eleventh PMOS transistor, a source terminal of the fourth NMOS transistor and a drain terminal of the sixth NMOS transistor are connected; a source terminal of the fifth NMOS transistor, a source terminal of the sixth NMOS transistor and a drain terminal of the seventh NMOS transistor are connected, and a source terminal of the seventh NMOS transistor is grounded.

9. The current mode weak-PUF circuit with rich challenge-response pairs according to claim 6, wherein the arbitrator comprises two two-input NAND gates, each two-input NAND gate has a first input terminal, a second input terminal and an output terminal, and the two two-input NAND gates are respectively designated a first two-input NAND gate and a second two-input NAND gate; the first input terminal of the first two-input NAND gate serves as the first input terminal of the arbitrator unit, the second input terminal of the second two-input NAND gate serves as the second input terminal of the arbitrator unit, the second input terminal of the first two-input NAND gate is connected to the output terminal of the second two-input NAND gate, the output terminal of the first two-input NAND gate is connected to the first input terminal of the second two-input NAND gate to form a connection terminal which serves as the output terminal of the arbitrator unit.
